(19) United States
(12) Patent Application Publication
(10) Pub. No.: US 2020/0122238 A1
(43) Pub. Date: Apr. 23, 2020

(54) LATHE LOADING CLAMP FOR SUPPORTING BARS AND RELATED BAR LOADER FOR LATHES

(71) Applicant: BUCCI AUTOMATIONS S.P.A., Faenza (IT)

(72) Inventors: Andrea GHINASSI, Faenza (IT); Marco MALUCELLI, Forli' (IT)

(21) Appl. No.: 16/628,995

(22) PCT Filed: Jul. 7, 2017
(86) PCT No.: PCT/IT2017/000139

§ 371 Date: Jan. 6, 2020

(51) Int. Cl. B23B 13/12

(52) U.S. Cl. CPC B23B 13/123

(57) ABSTRACT

A lathe loading clamp for supporting bars includes a main body provided with a shaft for coupling to a rotating assembly, which is substantially tapered at one of its ends, and a cavity at the opposite end. The cavity accommodates, with a predefined axial play, a bush, made of material that is at least partially polymeric, which has an axial channel having a diameter that is substantially complementary to the diameter of the bar to be supported. The axial channel (6), in the configuration for use, accommodates a portion of a bar.

### TECHNICAL FIELD

The present disclosure relates to a lathe loading clamp for supporting bars to be machined and also to a related bar loader for lathes (provided with the clamp according to the disclosure).

### BACKGROUND

The fully automated machining of raw materials is now used to provide a considerable number of mechanical parts.

In particular it is known to use automatic lathes that perform machinings in sequence on the bars that they are fed.

Obviously, automation of the entire machining cycle depends on the correct and continuous supply of bars: for this reason, bar loaders are normally used which are designed to supply the bars to be machined to a lathe, to which they are coupled.

Clearly, these loaders must supply the lathe with the bars, on which the machinings are to be performed, in such a manner that they can rotate integrally with the spindle of the lathe, maintaining the ideal alignment thereof and avoiding any flexing (which might trigger vibrational phenomena which are harmful for the quality of the machinings and for the lathe itself).

It is known to resort to clamps designed to retain the bars, provided with bar clamping means constituted by at least two jaws (or claws) which can be moved mutually closer until the bar is retained.

This type of clamp has the main drawback of reduced versatility, since each one is suitable to guide only bars of a predefined and very limited range of diameters.

Furthermore, the mechanical stresses to which traditional clamps are subjected make them subject to wear and to accidental breakages which entail frequent maintenance operations.

It should also be noted that traditional clamps, on bars having smaller diameters, do not allow optimum locking, with consequent possibility of vibrations and flexing of the bar (which, being slender, is also particularly delicate from this point of view).

### SUMMARY

The aim of the present disclosure is to solve the problems described above, by proposing a lathe loading clamp for supporting bars that is particularly versatile.

Within this aim, the disclosure provides a lathe loading clamp for supporting bars that is suitable to support and center narrow-diameter bars as well.

The disclosure also provides a lathe loading clamp for supporting bars that is scarcely subject to vibrations.

The disclosure further provides a lathe loading clamp for supporting bars that is suitable to limit the risk of flexing of said bars.

The disclosure also provides a lathe loading clamp for supporting bars that is scarcely subject to wear.

The disclosure provides a lathe loading clamp for supporting bars that requires little maintenance.

The present disclosure provides a lathe loading clamp for supporting bars that is relatively simple to provide in practice and is safe in application.

This aim and these advantages, as well as others which will become better apparent hereinafter, are achieved by providing a lathe loading clamp for supporting bars, characterized in that it comprises a main body provided with a shaft for coupling to a rotating assembly of the loader, which is substantially tapered at one of its ends, and with a cavity at the opposite end, said cavity accommodating, with a predefined axial play, a bush, made of material that is at least partially polymeric, which has an axial channel having a diameter that is substantially complementary to the diameter of the bar to be supported, said axial channel, in the configuration for use, accommodating a portion of a bar.

This aim and these advantages are also achieved by providing means of a bar loader for lathes of the type comprising a rotating assembly for the rotary support of a clamp for supporting at least one bar to be machined, characterized in that said clamp comprises a main body provided with a shaft for coupling to the rotating assembly which is substantially tapered at one of its ends, and with a cavity at the opposite end, said cavity accommodating, with a predefined axial play, a bush, made of at least partially polymeric material, which has an axial channel having a diameter that is substantially complementary to the diameter of the bar to be supported, said axial channel, in the configuration for use, accommodating a portion of a bar.

### BRIEF DESCRIPTION OF THE DRAWINGS

Further characteristics and advantages of the disclosure will become better apparent from the description of a preferred but not exclusive embodiment of the lathe loading clamp for supporting bars and of the related bar loader for lathes according to the disclosure, illustrated by way of non-limiting example in the accompanying drawings, wherein:

FIG. 1 is an exploded perspective view of a first version of a lathe loading clamp for supporting bars according to the disclosure;

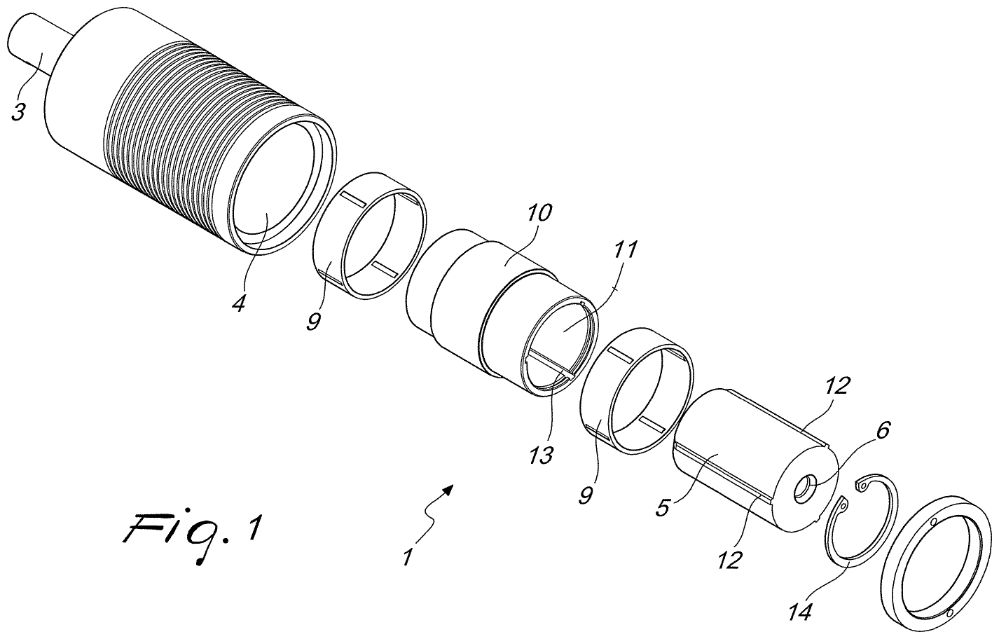

FIG. 2 is a sectional view, taken along an axial plane, of the clamp of FIG. 1;

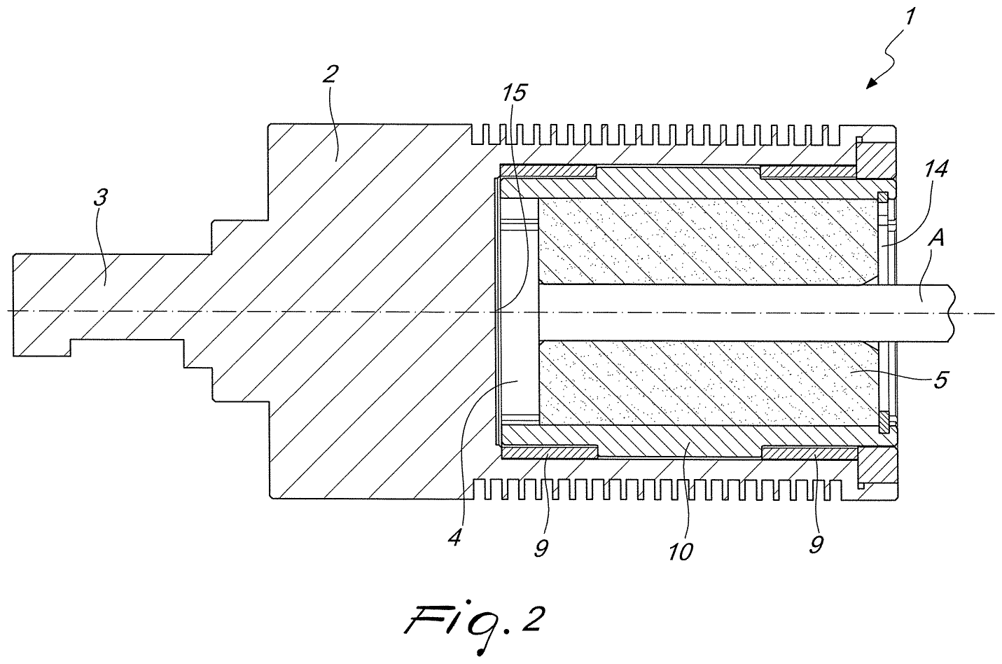

FIG. 3 is an exploded perspective view of a second version of a lathe loading clamp for supporting bars according to the disclosure; and

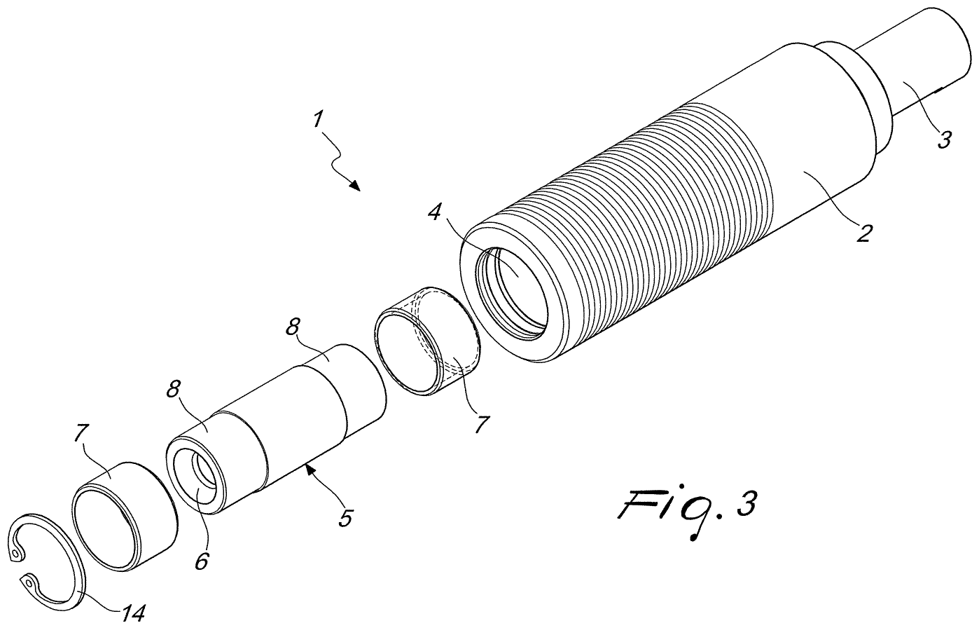

FIG. 4 is a sectional view, taken along an axial plane, of the clamp of FIG. 3.

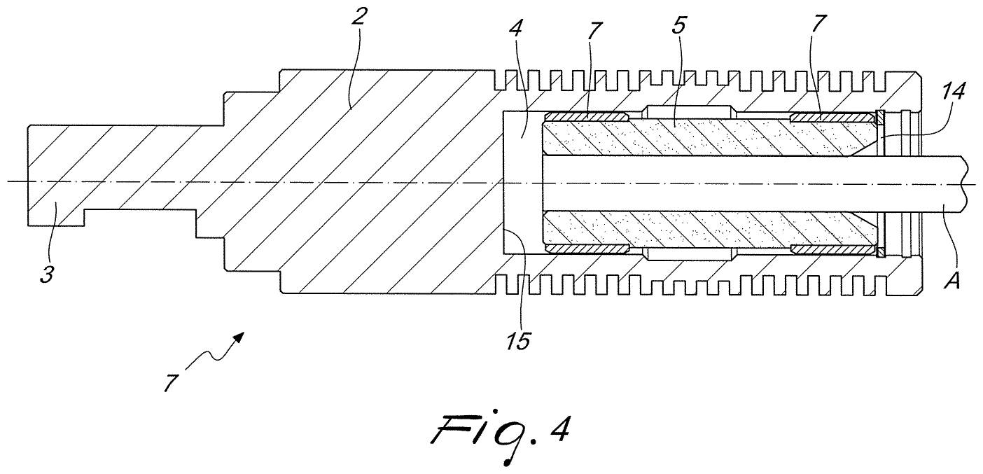

### DETAILED DESCRIPTION OF THE DRAWINGS

With particular reference to the figures above, the reference numeral 1 generally designates a lathe loading clamp for supporting bars.

The clamp 1 comprises a main body 2 provided with a shaft 3, for coupling to a rotating assembly of the loader, which is substantially tapered at one of its ends, and with a cavity 4 at the opposite end.

A bush 5 is accommodated inside the cavity 4, with a predefined axial play, is made of at least partially polymeric material, and has an axial channel 6 the diameter of which is substantially complementary to the diameter of the bar A to be supported.

When the clamp 1 is in the configuration for use inside the respective loader, the axial channel 6 accommodates a portion of a bar A (accommodation substantially without play).

The bush 5 can be made preferably of deformable material, in order to damp the vibrations of the bar A during its rotation. The deformable material used (for example of the polymeric or elastomeric or silicone type) has a friction coefficient, with respect to the bar A that is supported, that is suitable to generate an axial force (with respect to the axis of the bar A) suitable to recover the final portion of the bar A.

To provide the bush 5 it is possible to choose polymeric materials of a different type and shape (for example also foams and emulsions), elastomers and composite materials (which have an at least partially deformable matrix).

It is possible to interpose optionally and advantageously between the bush 5 and the cavity 4 antifriction elements (in other words, antifriction, self-lubricating or, in general, made of a material with a low surface friction rubbing coefficient) with reduced overall radial play.

According to a first possible constructive solution, the antifriction element can validly comprise at least one sleeve 7 made of self-lubricating material accommodated on the bush 5.

In this case the sleeve 7 is coupled stably to the external surface of the bush 5 and can rotate freely, integrally with the bush 5, within the cavity 4.

The bush 5 can comprise segments 8 having a reduced outside diameter, on which respective sleeves 7 are fitted: the surface finish of the segments 8 can be provided in order to facilitate a rigid and stable coupling to the sleeve 7 that will be associated with it.

The sleeve 7 can be made of self-lubricating material of the type of polyamides (this family includes some materials with an extremely low friction coefficient), polytetrafluoroethylene, polymeric materials comprising PEEK, polymers with the addition of silicone oils, waxes, mineral oils and mineral fillers, antifriction metallic alloys, antifriction composites and sintered materials.

The rotation of the bush 5 within the cavity 4 is therefore substantially free (scarcely subject to friction) by virtue of the presence of the sleeves 7, which slide on the internal surface of the cavity with a low friction coefficient.

As an alternative to the use of the sleeves 7, it is possible to use as antifriction element at least one bearing 9 which is accommodated, even indirectly, on the bush 5.

The bearing 9 is preferably of the roller, barrel, ball type and the like.

The accompanying figures show a clamp 1 provided with roller bearings 9 which perfectly achieves the intended aim and objects.

Furthermore, it is specified that a rigid tubular body 10 is interposed between the bush 5 and the at least one bearing 9.

The bush 5 is thus accommodated within the duct 11 that is internal to the tubular body 10 (with axial play in order to allow a slight axial sliding thereof within the cavity 4) and the at least one bearing 9 is in turn advantageously fitted onto the outer surface of the tubular body 10: the rigidity of the tubular body 10 ensures the correct positioning of the bearings 9 in order to maintain the alignment of the rollers and their consequent rolling with very low friction, without risk of jamming.

Furthermore, it is specified that the bush 5 has an external surface that is complementary to the internal surface of the internal duct 11 of the tubular body 10.

Respective protrusions 12 and seats 13 are present in the bush 5 and in the internal duct 11 and match up in the coupling configuration in order to eliminate relative rotational motions, in any case allowing translational motions in an axial direction (with reference to the axis of the bar A being machined).

At the terminal front of the cavity 4 there is an abutment ring 14 for locking the bush 5 within the cavity 4.

The abutment ring 14 can be a stop ring made of elastic steel, the circumference of which is not complete and at the two ends of which there are holes for the insertion of a tool of the Seeger type.

An axial play equal to the difference between a first distance, defined between the internal surface of the abutment ring 14 and the end surface 15 of the cavity 4, and the length of the bush 5 is defined between the bush 5 and the cavity 4.

It is important to specify that the outer surface of the main body 2, at the part thereof within which the cavity 4 is formed, favorably can be shaped in order to increase the radiating area for greater heat dissipation.

In particular, it is noted in the accompanying figures that said surface is substantially provided with fins, so as to dissipate easily the heat generated by the friction of the sleeves 7 or by the rolling of the rollers of the bearings 9.

The present disclosure extends its protection also to a loader of bars A for lathes, which comprises a rotating assembly for the rotatable support of a supporting clamp 1, which in turn comprises a main body 2 provided with a shaft 3 for coupling to the rotating assembly, which substantially tapers at one of its ends, and with a cavity 4 at the opposite end.

A bush 5 is conveniently accommodated within the cavity 4 of the clamp 1, with a predefined axial play, is made of at least partially polymeric material, and has an axial channel 6 the diameter of which is substantially complementary to the diameter of the bar A to be supported.

The axial channel 6, in the configuration for use, accommodates a portion of the bar A.

Advantageously, the present disclosure solves the problems described earlier, proposing a lathe loading clamp 1 for supporting bars A that is particularly versatile.

Conveniently, the clamp 1 is suitable to support and center also bars A having a small diameter.

Favorably, the clamp 1 is scarcely subject to vibrations, which in any case are dampened by the particular stress response of the bush 5 (elastic damping insured by the use of polymeric material and by the presence of an axial play that allows the bush to translate according to a predefined stroke within the cavity 4).

Positively, the clamp 1 according to the disclosure is suitable to limit the risk of flexing of said bars (owing to the elastic damping induced by it on the bar A and by virtue of the axial play that is present with respect to the cavity 4).

Effectively, the clamp 1 is scarcely subject to wear (this in particular by virtue of the specific materials used to provide the bush 5 and by virtue of the adoption of sleeves 7 made of antifriction material and/or bearings 9).

Advantageously, the clamp 1 requires limited maintenance.

Validly, the clamp 1 according to the disclosure is relatively simple to provide in practice and has modest costs: these characteristics render the clamp 1 according to the disclosure an innovation of assured application.

The disclosure thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

1-10. (canceled)

11. A lathe loading clamp for supporting bars, the clamp comprising:
a main body provided with a shaft for coupling to a rotating assembly, which is substantially tapered at one of its ends, and with a cavity at an opposite end, said cavity accommodating, with a predefined axial play, a bush, made of material that is at least partially polymeric, which has an axial channel having a diameter that is substantially complementary to a diameter of the bar to be supported, said axial channel, in the configuration for use, accommodating a portion of the bar.

12. The clamp according to claim 11, wherein at least one anti-friction element with reduced overall radial play is interposed between said bush and said cavity.

13. The clamp according to claim 12, wherein said anti-friction element comprises at least one sleeve made of self-lubricating material that is accommodated on said bush, said sleeve being coupled stably to the external surface of said bush and being able to rotate freely integrally with said bush, within said cavity.

14. The clamp according to claim 12, wherein said anti-friction elements comprise at least one bearing accommodated, even indirectly, on said bush.

15. The clamp according to claim 14, wherein said bearing is preferably a roller, a barrel, or a ball.

16. The clamp according to claim 14, wherein a rigid tubular body is interposed between said bush and said at least one bearing, said bush being accommodated in the duct that is internal to said tubular body and said at least one bearing being fitted on the external surface of said tubular body.

17. The clamp according to claim 16, wherein said bush has an external surface that is complementary with respect to the internal surface of the internal duct of said tubular body, respective protrusions and seats matching up in the coupling configuration to eliminate relative motions.

18. The clamp according to claim 11, wherein at a terminal front of said cavity there is an abutment ring for the locking of said bush within said cavity with an axial play that is equal to a difference between a first distance, defined between an internal surface of said abutment ring and a terminal surface of said cavity, and a length of said bush.

19. The clamp according to claim 11, wherein an external surface of said main body, at a part thereof within which said cavity is formed, is shaped so as to increase a radiating area for higher heat dissipation.

20. A lathe bar loader comprising a rotating assembly for a rotatable support of a clamp for supporting at least one bar to be machined, wherein said clamp comprises a main body provided with a shaft for coupling to the rotating assembly, which is substantially tapered at one of its ends, and with a cavity at an opposite end, said cavity accommodating, with a predefined axial play, a bush, made of at least partially polymeric material, which has an axial channel having a diameter that is substantially complementary to a diameter of the at least one bar to be supported, said axial channel, in a configuration for use, accommodating a portion of the bar.
